(19) United States
(12) Patent Application Publication
(10) Pub. No.: US 2026/0161832 A1
(43) Pub. Date: Jun. 11, 2026

(54) SYSTEM-ON-CHIP WITH DATA SECURITY BASED ON TRUST ZONE LINKAGE AND OPERATING METHOD THEREOF

(71) Applicant: HANWHA VISION CO., LTD., Seongnam-si (KR)

(72) Inventors: Taeyoung OH, Seongnam-si (KR); Kyoungsu JUN, Seongnam-si (KR); Gitae KIM, Seongnam-si (KR)

(73) Assignee: HANWHA VISION CO., LTD., Seongnam-si (KR)

(21) Appl. No.: 19/415,275

(22) Filed: Dec. 10, 2025

(30) Foreign Application Priority Data
Dec. 10, 2024 (KR) 10-2024-0182688

(51) Int. Cl. G06F 21/74; G06F 21/53

(52) U.S. Cl. CPC G06F 21/74; G06F 21/53; G06F 2221/034

(57) ABSTRACT

A data security method includes updating a seed value in an One Time Programmable (OTP) memory through a secure world based on a security mode being executed; and performing parallel processing on data input from at least one external device, in a byte-by-byte manner, based on the updated seed value using a crypto engine activated.

### CROSS-REFERENCE TO RELATED APPLICATION(S)

This application claims the priority under 35 U.S.C. § 119 to and the benefit of Korean Patent Application No. 10-2024-0182688 filed on Dec. 10, 2024, in the Korean Intellectual Property Office, the disclosure of which is incorporated by reference herein in its entirety.

### BACKGROUND

### 1. Field

The disclosure relates to a system-on-chip capable of providing data security based on trust zone linkage and an operating method of the system-on-chip.

### 2. Description of the Related Art

As fields such as the Internet of Things (IoT) rapidly grow, the amount of data transmitted and received over the Internet, is increasing exponentially. Consequently, data security is also emerging as a significant issue due to the increasing number of damage cases caused by leaks of personal and confidential information, creating a growing demand for robust data protection.

Typically, a System-on-Chip (SoC), which is a piece of hardware designed for data processing, integrating a central processing unit (CPU) and memory on a single chip. When the SoC lacks separate data security features, the program code stored in S-Flash, positioned outside the SoC, may be readily tampered with or replaced.

Therefore, without verification of program code, completely unrelated programs may be executed, potentially leading to data leaks and other issues. Software-based data security methods may be considered for data security, but it is difficult to apply such methods to existing hardware. Thus, SoC security requires careful consideration not only of chip-level design and system-level principles, but also of the overall product architecture.

The technology described above is provided to enhance a better understanding of the background of the disclosure. It may not be understood that the matters described in the technology are acknowledged as known technology by the present disclosure.

### SUMMARY

Conventionally, a system is constructed based on a crypto engine algorithm as a method for data security in SoC. However, these systems have characteristics that are relatively vulnerable to data security and have constraints in their application locations.

System configuration constraints may arise due to the characteristics of the crypto engine, inevitably leading to additional latency cycles. This may result in performance degradation. Furthermore, there was an issue with system configuration constraints may exist regarding the IP interface protocol and the package size required for each crypto engine.

Accordingly, the disclosure provides a method and a device capable of enhancing data security without constraints on interfaces and without delay loss.

Accordingly, an object to be achieved by the disclosure is to provide a system-on-chip and its operating method capable of providing data security based on trust zone linkage, which is applied to a majority of locations by preventing interface constraints and data loss due to delays, as it processes data input from an external device through an encryption engine and a decryption engine in conjunction with a trust zone.

Another object to be achieved by the disclosure is to provide a system-on-chip and its operating method capable of providing data security based on trust zone linkage, which not only allows multiple application of the IP or insertion of the IP as a module into the IP, but also allows almost no area loss even when the IP is applied multiple times due to the small size of the logic.

Objects of the disclosure are not limited to the above-mentioned objects, and other objects not mentioned will be clearly understood by those skilled in the art from the description below.

To achieve the above-described objects, a method of operating a system-on-chip that provides data security based on trust zone linkage according to an embodiment of the disclosure is provided. The method may include, updating a seed value in a One Time Programmable (OTP) memory through a secure world linked to a trust zone based on a security mode being executed; and performing parallel processing on data input from at least one external device, in a byte-by-byte manner, based on the updated seed value using the crypto engine activated.

According to a feature of the disclosure, the performing of the parallel processing on the data may include performing scrambling through an encryption engine in the crypto engine or performing descrambling through a decryption engine in the crypto engine, based on a logical operation.

According to a feature of the disclosure, the logical operation may be at least one of an exclusive-OR (XOR) operation and a rotation operation.

According to a feature of the disclosure, each of the scrambling and the descrambling may be performed in units of 4 bits or 8 bits.

According to a feature of the disclosure, the seed value may be fused to the OTP memory during an OTP programing operation.

According to a feature of the disclosure, the seed value may be updated differently for each of the at least one external device.

According to a feature of the disclosure, the secure world may be configured to operate as a Trusted Execution Environment (TEE) area of a CPU.

According to a feature of the disclosure, a normal world may be configured to operate as a Rich Execution Environment (REE) of the CPU.

To achieve the above-described objects, a system-on-chip that provides data security based on trust zone linkage according to an embodiment of the disclosure is provided. The system-on-chip may include a processor including at least one core configured to execute program code; a One Time Programmable (OTP) memory configured to store a seed value generated during an OTP programing operation; a crypto engine configured to perform scrambling through an encryption engine in the crypto engine or performing descrambling through a decryption engine in the crypto engine based on a logical operation; a system bus configured to provide a data transfer path; and an integrated controller configured to update the seed value stored in the OTP memory through a secure world linked to a trust zone based on a secure mode being executed, and to parallel processing on data input from at least one external device, in a byte-by-byte manner, based on the updated seed value using the crypto engine being executed.

According to a feature of the disclosure, the logical operation may include at least one of an exclusive-OR (XOR) operation and a rotation operation.

According to a feature of the disclosure, each of the scrambling and the descrambling may be performed in units of 4 bits or 8 bits.

According to a feature of the disclosure, the seed value may be programmed into the OTP memory during an OTP programing operation.

According to a feature of the disclosure, the integrated controller may be configured to update the seed value differently for each of the at least one external device.

According to a feature of the disclosure, the secure world may be provided in a trusted execution environment (TEE) of a central processing unit (CPU).

According to a feature of the disclosure, a normal world may be configured to operate as a Rich Execution Environment (REE) of the CPU. Specific details of other embodiments are included in the detailed description and drawings.

The disclosure is applicable to most systems by preventing interface constraints and delay-induced performance degradation, as it processes data input from an external device through an encryption engine and a decryption engine in conjunction with a trust zone.

On the other hand, the disclosure not only enables multiple applications of the IP or insertion of the IP as a module into the IP, but also ensures almost no area loss even when the IP is applied multiple times due to the small size of the logic.

The effects according to the disclosure are not limited to the contents described above, and more various effects are included in the disclosure.

### BRIEF DESCRIPTION OF DRAWINGS

FIG. 1 is a block diagram of the configuration of a system-on-chip according to a comparative example.

FIG. 2 is a block diagram of the configuration of a system-on-chip capable of providing data security based on trust zone linkage according to an embodiment of the disclosure.

FIG. 3 is a block diagram for describing a data processing operation of a system-on-chip capable of providing data security based on trust zone linkage according to an embodiment of the disclosure.

FIG. 4 is a flowchart illustrating a method of operating a system-on-chip capable of providing data security based on trust zone linkage according to an embodiment of the disclosure.

FIGS. 5A and 5B are block diagrams illustrating an example of a scrambling operation and a descrambling operation performed in a system-on-chip capable of providing data security based on trust zone linkage according to an embodiment of the disclosure.

FIGS. 6A, 6B, and 6C are timing diagrams illustrating examples of unused signals when processing data according to an embodiment of the disclosure.

### DETAILED DESCRIPTION

The advantages and features of the disclosure, and the methods for achieving them, will become clear with reference to the embodiments described in detail below together with the attached drawings. However, the disclosure is not limited to the embodiments disclosed below, but the embodiments may be implemented in various different forms, and these embodiments are provided only to make the disclosure of the disclosure complete and to fully inform a person having ordinary knowledge in the technical field to which the disclosure belongs of the scope of the disclosure, and the disclosure is defined only by the scope of the claims. In relation to the description of the drawings, similar reference numerals may be used for similar components.

In the disclosure, the expressions “have”, “can have”, “include”, or “can include” refer to the presence of a feature (for example, a numerical value, function, operation, or component such as a part) and do not exclude the presence of additional features.

In the disclosure, the expressions “A or B”, “at least one of A or/and B”, or “one or more of A or/and B” may include all possible combinations of the items listed together. For example, “A or B”, “at least one of A and B”, or “at least one of A or B” may all refer to (1) including at least one A, (2) including at least one B, or (3) including both at least one A and at least one B.

The expressions “first”, '7 second”, “firstly”, or '7 secondly”, used in the disclosure may describe various components, regardless of order and/or importance, and are used only to distinguish one component from another, but do not limit the components. For example, a first user device and a second user device may represent different user devices, regardless of order or importance. For example, without departing from the scope of the rights set forth in the disclosure, a first component may be referred to as a second component, and similarly, a second component may be referred to as a first component.

When a component (for example, a first component) is referred to as being “(operatively or communicatively) coupled with/to” or “connected to” another component (for example, a second component), it may be understood that said component may be directly connected to said other component, or may be connected via another component (for example, a third component). When it is said that a component (for example, a first component) is “directly connected” or “directly connected” to another component (for example, a second component), it may be understood that no other component (for example, a third component) exists between said component and said other component.

The expression “configured to” as used in the disclosure may be used interchangeably with, for example, “suitable for”, “having the capacity to”, “designed to”, “adapted to”, “made to”, or “capable of, depending on the situation. “The term “configured (or set) to” does not necessarily mean that something is “specifically designed to” in terms of hardware. Instead, in some contexts, the expression “a device configured to” may mean that the device is “capable of” doing something in conjunction with other devices or components. For example, the phrase “a processor configured (or set) to perform A, B, and C” may mean a dedicated processor (for example, an embedded processor) for performing the operations, or a general-purpose processor (for example, a CPU or an application processor) that performs the operations by executing one or more software programs stored in a memory device.

The terms used in the disclosure are used only to describe specific embodiments and cannot be intended to limit the scope of other embodiments. The singular expression may include the plural expression unless the context clearly indicates otherwise. Terms used herein, including technical or scientific terms, may have the same meaning as commonly understood by a person of ordinary skill in the art described in the disclosure. Terms defined in general dictionaries among the terms used in the disclosure may be interpreted as having the same or similar meaning as they have in the context of the relevant technology, and shall not be interpreted in an ideal or excessively formal sense unless explicitly defined in the disclosure. In some cases, even if a term is defined in the disclosure, it cannot be interpreted to exclude embodiments of the disclosure.

Each feature of the various embodiments of the disclosure may be partially or entirely combined or combined with each other, and as may be fully understood by those skilled in the art, various technical connections and operations are possible, and each embodiment may be implemented independently of each other or may be implemented together in a related relationship.

Hereinafter, preferred embodiments of the disclosure will be described in detail with reference to the accompanying drawings.

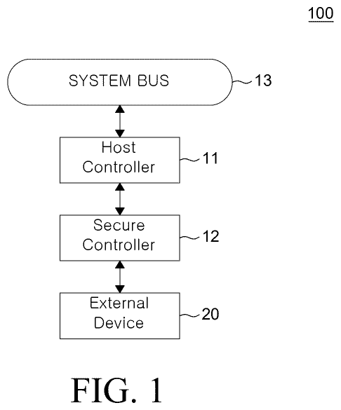

FIG. 1 is a schematic diagram illustrating the configuration of a system-on-chip according to a comparative example.

Referring to FIG. 1, a system-on-chip (hereinafter, referred to as “SoC”) 100 may include a host controller 11, a secure controller 12, and a system bus 13.

The SoC 100 may include a processor, a bus, a memory, a register, etc. inside single chip, and may be composed of an intellectual property (IP) units that performs an operation according to designed specification as well as a communication structure that interconnects the IP units.

This SoC 100 may be included in, for example, an electronic device such as a server, a computer, a smartphone, a tablet, a personal digital assistant (PDA), a digital camera, a portable media player (PMP), a wearable device, an Internet of Things (IoT) device, or the like, but embodiments are not limited thereto.

For example, the host controller 11 may be implemented in the host module and may be connected to the system bus 13 to control the operation of a host module. For example, the host module may include various functional modules for operating the SoC 100 in addition to the host controller 11.

The secure controller 12 may be implemented (or provided) in the secure module and may be connected to the system bus 13 like the host controller 11 to control the operation of the secure module. The secure controller 12 may be connected to a crypto engine implemented (or provided) in the secure module. This crypto engine may encrypt data stored in memory in the secure module.

The SoC 100 may exchange data and/or power with other semiconductor devices, circuit elements, batteries, and the like through a circuit board. For example, the SoC 100 may have a system bus 13 therein, through which data and/or power are exchanged.

For example, the system bus 13 may provide signal paths for data transmission path (e.g., input/output path) and/or command exchange, and other operations.

For example, the SoC 100 may be connected to an external device 20, e.g., a device positioned outside the SoC due to a storage capacity limitations or restricted area. Although FIG. 1 illustrates only one external device 20, at least one external device 20 may be provided. For example, the external device 20 may include at least one memory. For example, the at least one memory may be composed of a non-volatile memory and/or a volatile memory, and may be composed of at least one of a dynamic random access memory (DRAM), a static random access memory (SRAM), a synchronous dynamic random access memory (SDRAM), a double data rate SDRAM (DDR SDRAM), a resistive random access memory (RRAM or ReRAM), a phase change random access memory (PRAM), or a ferroelectric random access memory (FRAM).

When one memory among at least one memory included in the external device 20 is booted, information regarding a data parallelization method may be transmitted to the SoC 100. However, this is an example, and the external device 20 may also transmit the information regarding the data parallelization method to the SoC 100 at times than during boot-up.

In addition to the components included in the SoC 100 illustrated in FIG. 1, additional processors and various IP units may be included. For example, the SoC 100 may include IP units such as a graphics processing unit (GPU) for graphics processing, a memory controller that controls DRAM and/or flash memory, and an input/output interface connected to other semiconductor devices, in addition to a processor having cores (e.g., central processing units) that execute operation and control operations.

The SoC 100 of FIG. 1, according to the comparative example, may have constraints in applicability due to differences in the interface protocols between the host controller 11 and the crypto engine, and latency loss may occur, potentially compromising data security. Furthermore, there may be constraints on the data packet size required by each crypto engine.

The disclosure proposes a SoC and an operating method thereof that cannot cause delay loss without constraint of an interface protocol.

Several data security technologies may be applied to protect secure data from hacking. One such data security method, utilizing trust zone, may divide hardware such as memory into a normal world (or a non-secure domain) and a secure world (or secure domain) corresponding to the trust zone, and may prevent access to resources in the secure world from the normal world, thereby allowing data to be input, stored, and protected through the secure world. For example, the hardware may operate separately in a secure mode and a normal mode.

Since the secure world is implemented (or provided) by the trust zone and guarantees data security, the secure world may function as a Trusted Execution Environment (TEE), and the normal world may function as a Rich Execution Environment (REE) because rich hardware resources are guaranteed without being restricted by hardware resources such as those in the trust zone. For example, the REE and the TEE may be implemented to be physically isolated from the SoC. For example, the secure world may be linked to the trust zone. The secure world may be provided by the trust zone or implemented in the trust zone or based on the trust zone.

For example, the TEE may perform security-required operations, control security-related components, and may transmit and receive secure data. For example, the REE may perform general operations that do not require data security, control non-security-related components, and may transmit and receive general data.

For example, the SoC may operate in a normal mode and a secure mode. When the SoC is determined to be operated in the normal mode, only components related to the normal mode may be booted to activate only the normal world related to the REE, and the secure world may not be activated. On the other hand, when the SoC is determined to operate in the security mode, components related to the security mode may be booted to activate the secure world related to the TEE, and components related to the normal mode may be also booted to activate the normal world.

The SoC according to an embodiment of the disclosure, may process not only the pure data area, but also may operate in conjunction with the trust zone to ensure that the seed value is securely protected.

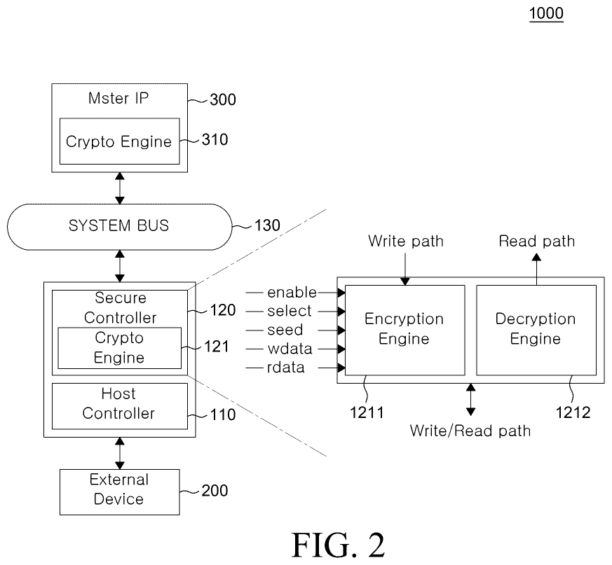

FIG. 2 is a schematic diagram illustrating the configuration of a system-on-chip capable of providing data security based on trust zone linkage according to an embodiment of the disclosure.

Referring to FIG. 2, the SoC 1000 capable of providing data security based on trust zone linkage according to an embodiment of the disclosure may include a host controller 110, a secure controller 120, and a system bus 130. For example, the SoC 1000 may be the same as the component included in the SoC 100 of FIG. 1 according to the above-described comparative example, and the functions of each component may also be performed in the same manner. Hereinafter, each component of the SoC 1000, as described in the disclosure, will be described, with an emphasis on operations that differ from those of the SoC 100 of FIG. 1 according to the comparative example.

For example, the SoC 1000 may be connected to the external device 200 and the master IP 300 through the system bus 130.

For example, the master IP 300 may include all blocks and/or IP units capable of providing data to the external device 200, and may communicate with the SoC 1000 via the system bus 130 to exchange data. Although only one master IP 300 is illustrated in FIG. 2, there may be at least one, and the number thereof is not limited thereto. For example, the master IP 300 may also include a crypto engine 310.

The SoC 1000 may be linked with the trust zone to protect the data of the master IP 300 through the trust zone.

For example, the trust zone may store secure data or security codes, as well as data necessary for the secure module to perform data security operations. For example, the secure data, security codes, encryption codes, or the like stored in the trust zone may be executed by the secure controller 120.

For example, the crypto engine 121 included in the secure controller 120 may include an encryption engine 1211 and a decryption engine 1212 and may receive secure data, security codes, or encryption codes from the linked trust zone to encrypt data through the encryption engine 1211 or to decrypt encrypted data through the decryption engine 1212.

For example, each of the encryption engine 1211 and the decryption engine 1212 may be activated by an enable signal received from the trust zone.

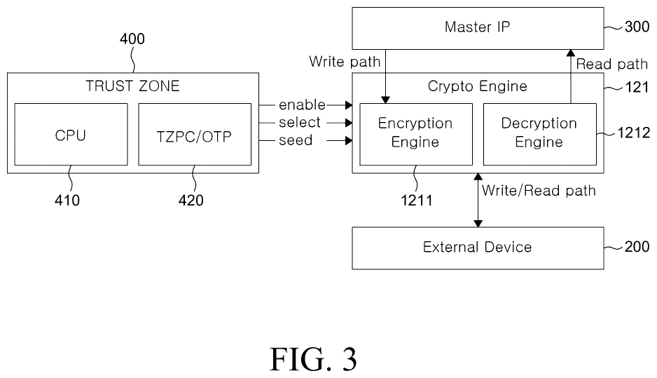

FIG. 3 illustrates a data processing operation of a system-on-chip capable of providing data security based on trust zone linkage according to an embodiment of the disclosure.

As described above, the SoC 1000 may include a central processing unit and at least one memory, and the trust zone 400 may be formed based on the central processing unit 410 and at least one memory, e.g., a One Time Programmable (OTP) memory 420.

When the SoC 1000 boots and the secure mode is executed, the secure controller 120 may update the seed value stored in the OTP memory 420 via the linked trust zone. Thereafter, when the crypto engine 121 is activated in response to an enable signal output from the central processing unit 410, the crypto engine 121 may process data input from at least one external device in parallel, in a byte by byte manner, based on the updated seed value.

For example, it may be verified whether the seed value is fused in the OTP memory 420 while initializing the security environment during the manufacturing process of the electronic device equipped with the SoC 1000 or the initial booting after manufacturing. For example, the fusion of the seed value may be verified by checking the bit values of the designated area of the OTP memory 420.

The seed value (or key value) may be fused into the OTP memory 420, but may be controlled through the TEE-based central processing unit 410 to prevent exposure. For example, the seed value may be fused into the OTP memory 420 during the factory stage, e.g., during the chip testing process performed during OTP programming operation.

The crypto engine 121 of the SoC 1000 may be composed of a combination of various seed values and engine algorithms since these seed values and engine algorithms may be set and combined only through the TEE area or the OTP (or TZPC), a unique security system may be configured for each device. For example, information stored by a device A may not be restored on a device B.

Accordingly, the crypto engine 121 may encrypt data stored in a specified memory among the at least one memory included in the external device 200 or may decrypt the encrypted data by using the secure data, security codes, and/or encryption codes provided from the OTP memory 420. For example, the secure data, security codes, and/or encryption codes provided from the OTP memory 420 may be controlled (or managed) by the TEE-based central processing unit 410.

For example, the encryption engine 1211 may encrypt data based on a seed value stored in the OTP memory 420 to output encrypted data, and the decryption engine 1212 may decrypt the encrypted data based on the seed value stored in the OTP memory 420 to output decrypted data.

Both encrypted data and decrypted data output from each of the encryption engine 1211 and decryption engine 1212 may perform write transactions and read transactions, respectively, through a data transmission path provided by the bus 130, e.g., a write path and a read path.

The crypto engine 121 may perform operations by transmitting data to the encryption engine 1211 or the decryption engine 1212 only when an encryption operation or a decryption operation is required.

For example, the encrypted data and the decrypted data may be transmitted to the master IP 300. For example, raw data and other data may be stored in the master IP 300, thereby protecting content including the data.

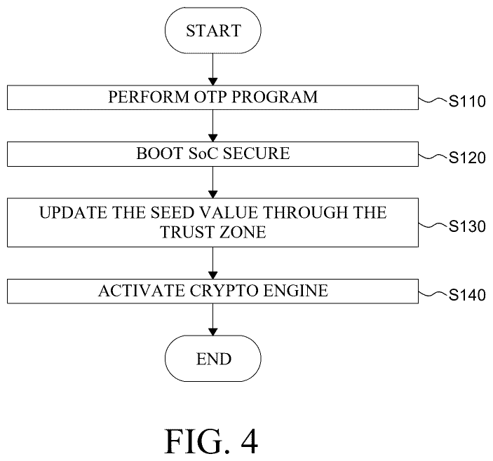

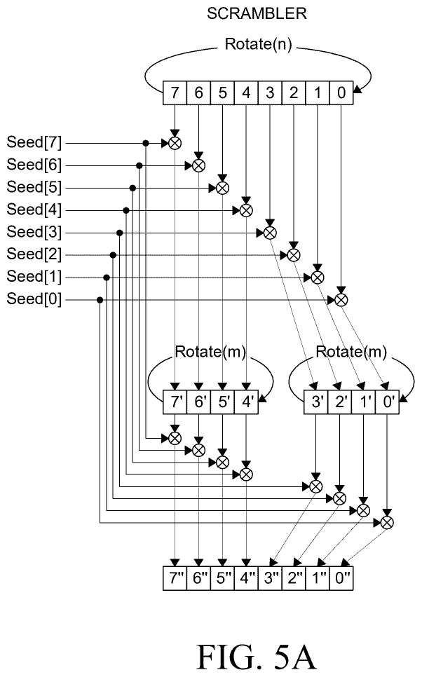

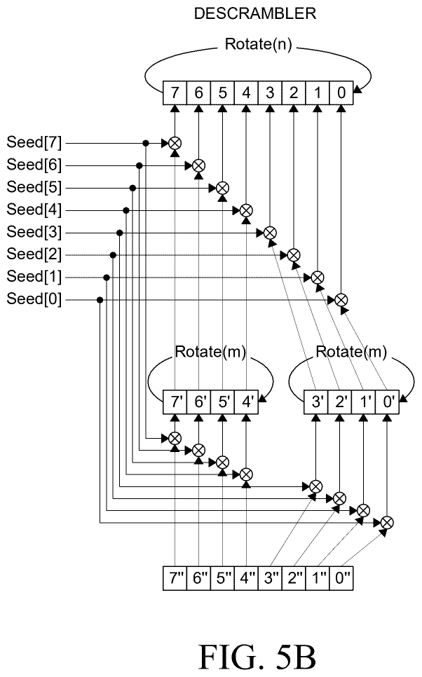

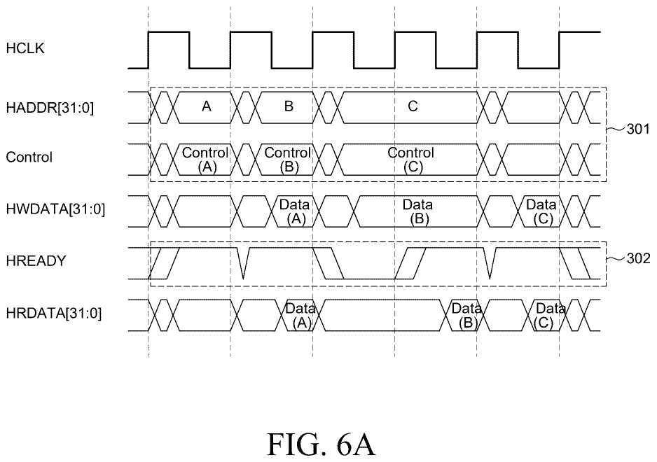

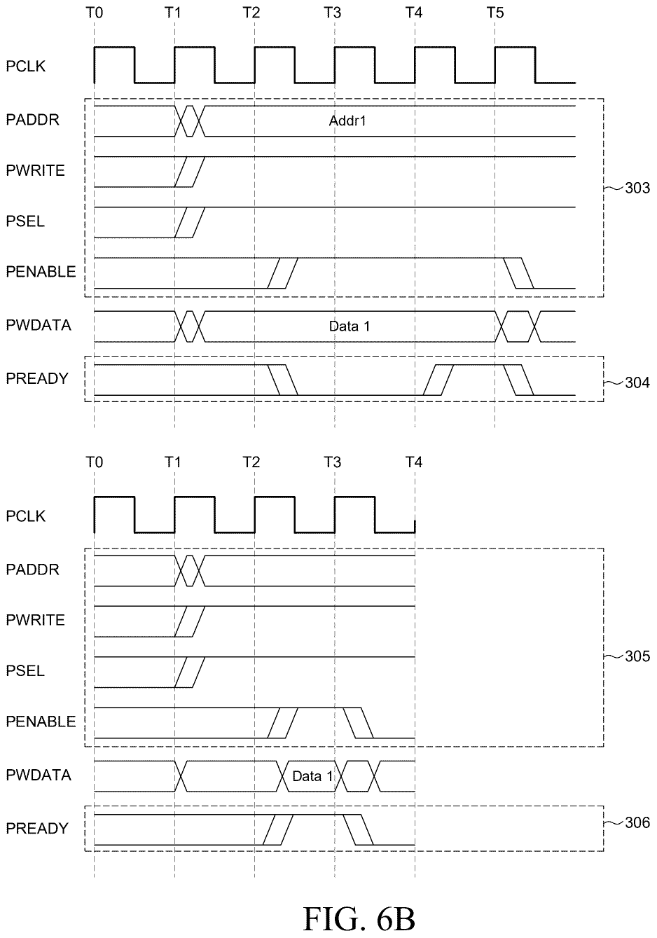

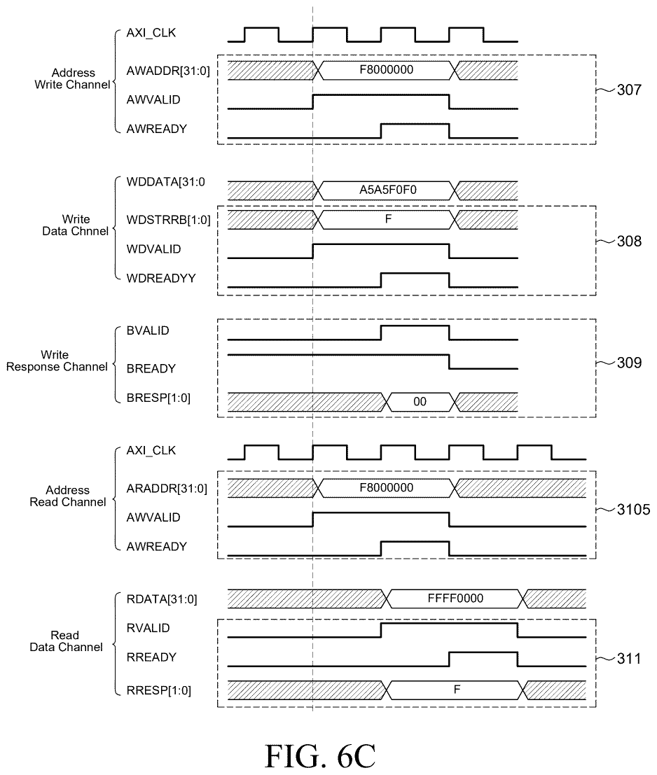

FIG. 4 is a flowchart illustrating a method of operating a system-on-chip capable of providing data security based on trust zone linkage according to an embodiment of the disclosure. For example, hereinafter, specific operations and details will be described based on an example with reference to FIGS. 5A, 5B, 6A, 6B, and 6C to describe each step of FIG. 4.

Referring to FIG. 4, an OTP programing operation may be performed during a manufacturing process or a manufacturing step of an electronic device provided with the SoC 1000, e.g., a factory step (or a production step) (S110). For example, a seed value may be fused to the OTP memory 420.

When the SoC 1000 boots and the security mode is executed (S120), the secure controller 120 may update the seed value in the OTP memory 420 through the linked trust zone (S130).

The seed value updated in step S130 may be stored and may then be used to encrypt or decrypt data.

When the crypto engine 121 is activated in response to an enable signal output from the central processing unit 410, data input from at least one external device may be processed in parallel in a byte-by-byte manner based on the seed value updated in step S130 (S140).

Step S140 may be performed to encrypt or decrypt data as shown in FIGS. 5A and 5B.

As illustrated in FIGS. 5A and 5B, the encryption engine 1211 and the decryption engine 1212 may perform encryption and decryption, respectively, using the seed value updated in step S130. For example, the encryption engine 1211 may perform scrambling based on logical operations, while the decryption engine 1212 may perform descrambling based on corresponding inverse logical operations. Referring to FIG. 5A, the encryption engine 1211 may scramble input data by applying logical operations such as exclusive-OR (XOR) and bit rotation. Referring to FIG. 5B, the decryption engine 1212 may descramble the scrambled data by applying the corresponding inverse logical operations. For example, bit operations may be performed in units of 4 bits (nibble) or 8 bits (byte), but this is an example, and the unit is not limited thereto.

In FIGS. 5A and 5B, reference numerals Seed [7:0] may denote an 8-bit seed value supplied from the secure world such as a TEE or an OTP memory. Each bit Seed [7], Seed [6], Seed [5], Seed [4], Seed [3], Seed [2], Seed [1], and Seed [0] may independently contribute to the XOR logic nodes in the scrambler or descrambler. A block labeled “Rotate (n)” may denote an 8-bit cyclic rotation module that rotates the entire byte by n bit positions, and a block labeled “Rotate (m)” may denote 4-bit cyclic rotation modules that rotate the upper nibble (7′, 6′, 5′, 4′) and the lower nibble (3′, 2′, 1′, 0′) by m bit positions. The nodes indicated with an XOR symbol may represent exclusive-OR operations combining the rotated bits with the seed bits. The final bit positions 7″, 6″, 5″, 4″, 3″, 2″, 1″, 0″ may represent the scrambled output, while the descrambler of FIG. 5B may apply reverse operations to restore the original 8-bit data.

As described above, the disclosure may not use operations that cause performance degradation, such as subtraction, multiplication, or division, but it may be implemented in a simple manner, using basic logic operations, such as exclusive-OR (XOR) and/or bit rotation. For example, various seed and rotation values may be variously set through the trust zone (TEE O/S or OTP), enabling data security to be implemented in different ways for each device. When the seed value is different for each device, each device may effectively have its own unique security engine.

Accordingly, data parallel processing may be performed at the nibble or byte level, making the technique applicable to all systems supporting 8 bits or more. Since only the pure data area is processed, the data parallel processing may be performed without protocol constraints. Further, the parallel processing may be linked with the trust zone so that the data security of the seed value may be fully maintained.

FIGS. 6A, 6B, and 6C are diagrams illustrating examples of unused signals during data processing according to an embodiment of the disclosure.

As shown in FIGS. 6A, 6B, and 6C, signals within the regions indicated by the dotted regions 301, 302, 303, 304, 305, 306, 307, 308, 309, 3105, and 311 may not need to be used.

FIG. 6A illustrates an example of signal transitions of an advanced high-performance bus (AHB) interface, including an address phase and a data phase. The illustrated signals may include an HCLK signal, HADDR[31:0] signals, various control signals, HWDATA[31:0] signals, an HREADY signal, and HRDATA[31:0] signals.

The dotted region 301 may denote regions in which address and control signals (A, B, and C) for successive bus transfers are toggled or driven according to the AHB protocol. For example, the corresponding signal transitions in region 301 may be unused during internal data processing. For example, the dotted region 302 may denote regions in which HREADY signal transitions occur for each transfer segment A, B, and C. Since the data processing according to an embodiment may operate on byte-level data in the crypto engine, without AHB cycle constraints, the HREADY transitions in the region 302 may not be required.

For example, FIG. 6A demonstrates that when data processing is separated from the AHB protocol, e.g., such as by decoupling the crypto engine using internal buffering or seed-based processing, numerous signal transitions defined by AHB (e.g., address, control, ready, or phase-based timing) may remain unused, thereby reducing dependency on specific protocol constraints.

FIG. 6B illustrates advanced peripheral bus (APB) signal waveforms for two consecutive write operations. The signals may include PCLK, PADDR, PWRITE, PSEL, PENABLE, PWDATA, and PREADY. In the upper portion of FIG. 6B, dotted regions 303 and 304 may indicate signal operations during a first APB write transaction. Region 303 may include the transition of PADDR to Addr1, assertion of PSEL, generation of PENABLE, and the stable phase of PWDATA (e.g., Data1). Dotted region 304 may include PREADY transitions for confirming completion. Further, dotted regions 305 and 306 may indicate a second write transfer in a similar manner.

However, according to the disclosure, since internal scrambling or descrambling in the crypto engine is performed on the data itself, these APB protocol steps (e.g., address setup, write enable, PENABLE cycles, or PREADY wait cycles) may not need to be used by the crypto engine. The engine may operate independently of APB timing such that only the pure data (PWDATA) may be relevant. Thus, the dotted regions 303, 304, 305, and 306 may contain signal transitions that are unused for internal data processing.

FIG. 6C illustrates write and read channel waveforms of an advanced eXtensible interface (AXI). The AXI may divide operations into five channels: write address, write data, write response, read address, and read data. The address write channel signals (e.g., AWADDR[31:0], AWVALID, AWREADY) are shown in region 307. The write data channel signals (e.g., WDATA [31:0], WSTRB, WVALID, WREADY) are shown in the dotted region 308. The write response channel signals (e.g., BVALID, BREADY, BRESP) are shown in the dotted region 309. The address read channel signals (e.g., ARADDR[31:0], ARVALID, ARREADY) appear in the dotted region 3105. The read data channel signals (e.g., RDATA[31:0], RVALID, RREADY, RRESP) may appear in the dotted region 311.

In normal AXI operation, each of the five channels may coordinate read and write operations through multiple handshakes (e.g., VALID/READY). However, according to the disclosure, since the internal security-based data processing may require raw data values and may not depend on AXI addressing, strobes, valid/ready signaling, or response cycles, all the shaded or boxed regions 307, 308, 309, 3105, and 311 may represent sequences that are unnecessary for internal crypto engine processing.

FIG. 6C illustrates that when the crypto engine decouples an internal data processing from external AXI protocol behavior, the handshake and response cycles defined by AXI may not be used for internal data handling.

This may be because data processing and interface processing are separated, such that only pure data may be processed, there may be no constraints according to protocol, and IP blocks supporting various interfaces may also be applicable.

As described above, according to the disclosure, by processing data input from an external device through an encryption engine and a decryption engine in conjunction with a trust zone, it is possible to prevent interface constraints and delay losses and make them applicable to most locations. According to the disclosure, the embodiment may not only enable multiple applications of the IP blocks or insertion of the IP blocks as a module into the IP blocks, but may also minimize area loss even when the IP blocks is applied multiple times due to the small size of the logic.

At least one of the components, elements, modules, units, or the like (collectively “components” in this paragraph) represented by a block or an equivalent indication (collectively “block”) in the above embodiments including the drawings, for example, FIGS. 1-4 may be physically implemented by analog and/or digital circuits including one or more of a logic gate, an integrated circuit, a microprocessor, a microcontroller, a memory circuit, a passive electronic component, an active electronic component, an optical component, and the like, and may be driven by software and/or firmware implemented by computer instruction codes stored in one or more internal or external memories to perform the functions or operations described herein. These components may, for example, be embodied in one or more semiconductor chips, or on substrate supports such as printed circuit boards and the like. These circuits may also be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks. Likewise, the blocks of the embodiments may be physically combined into more complex blocks.

Although the embodiments of the disclosure have been described in more detail with reference to the attached drawings, the disclosure is not necessarily limited to these embodiments, and various modifications may be made without departing from the technical idea of the disclosure. Accordingly, the embodiments disclosed in the disclosure are not intended to limit the technical idea of the disclosure, but to explain it, and the scope of the technical idea of the disclosure is not limited by these embodiments. Therefore, it may be understood that the embodiments described above are examples in all aspects and not restrictive. The protection scope of the disclosure may be interpreted by the claims below, and all technical ideas within the equivalent scope may be interpreted as being included in the scope of the rights of the disclosure.

What is claimed is:

1. A method of operating a system-on-chip (SoC) that provides data security based on trust zone linkage, the method comprising
updating a seed value in a One Time Programmable (OTP) memory through a secure world linked to a trust zone based on a security mode being executed; and
performing parallel processing on data input from at least one external device, in a byte-by-byte manner, based on the updated seed value using a crypto engine activated.

2. The method of claim 1, wherein the performing the parallel processing on the data comprises performing scrambling through an encryption engine in the crypto engine or performing descrambling through a decryption engine in the crypto engine, based on a logical operation.

3. The method of claim 2, wherein the logical operation comprises at least one of an exclusive-OR (XOR) operation and a rotation operation.

4. The method of claim 2, wherein each of the scrambling and the descrambling is performed in units of 4 bits or 8 bits.

5. The method of claim 1, wherein the seed value is fused into the OTP memory during an OTP programing operation.

6. The method of claim 1, wherein the seed value is updated differently for each of the at least one external device.

7. The method of claim 1, wherein the secure world is configured to operate as a Trusted Execution Environment (TEE) area of a central processing unit (CPU).

8. The method of claim 7, wherein a normal world is configured to operate as a Rich Execution Environment (REE) of the CPU.

9. A system-on-chip comprising,
a processor comprising at least one core configured to execute program code;
a One Time Programmable (OTP) memory configured to store a seed value generated during an OTP programing operation;
a crypto engine configured to perform scrambling through an encryption engine in the crypto engine or perform descrambling through a decryption engine based on a logical operation;
a system bus configured to provide a data transfer path; and
an integrated controller configured to update the seed value stored in the OTP memory through a secure world linked to a trust zone based on a secure mode being executed, and to perform parallel processing on data input from at least one external device, in a byte-by-byte manner, based on the updated seed value using the crypto engine being executed.

10. The system-on-chip of claim 9, wherein the logical operation comprises at least one of an exclusive-OR (XOR) operation and a rotation operation.

11. The system-on-chip of claim 9, wherein each of the scrambling and the descrambling is performed in units of 4 bits or 8 bits.

12. The system-on-chip of claim 9, wherein the seed value is programmed into the OTP memory during an OTP programing operation.

13. The system-on-chip of claim 9, wherein the integrated controller is configured to update the seed value differently for each of the at least one external device.

14. The system-on-chip of claim 9, wherein the secure world is provided in a trusted execution environment (TEE) of a central processing unit (CPU).

15. The method of claim 14, wherein a normal world is configured to operate as a Rich Execution Environment (REE) of the CPU.
